(19) United States
(12) Patent Application Publication
(10) Pub. No.: US 2003/0137595 A1
(43) Pub. Date: Jul. 24, 2003

(54) IMAGE PICKUP DEVICE AND CAMERA

(76) Inventor: TAIZO TAKACHI, KANAGAWA (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/078,019

(22) Filed: May 13, 1998

(30) Foreign Application Priority Data
May 16, 1997 (JP) P09,126553

(51) Int. Cl. H04N 5/225

(52) U.S. Cl. 348/340; 348/374

(57) ABSTRACT

Disclosed is an image pickup device which makes it possible to reduce the number of parts, to achieve a reduction in assembly man-hours, to meet the demand for a reduction in size, to facilitate the adjustment of the focal length, and to prevent the focal length from going out of adjustment after the adjustment of the focal length.

A package 3 accommodating an image sensing device 4 is integrally combined with an optical component holding member 8a holding an optical component for forming an image of an object on the surface of the image sensing device 4, with a certain positional relationship between the optical component and image sensing device in the X, Y and Z-directions being determined, by engaging an engagement step portion 15 with an engagement claw 16. Further, a focal length adjusting spacer 19 is arranged between the package 3 and the optical component holding member 8a, and a biasing member 18 for biasing the optical component 10 toward the package 3 is provided between the image sensing device accommodating package 3 and the optical component 10.

### BACKGROUND OF THE INVENTION

1. Field of the Invention

The present invention relates to an image pickup device formed by combining a package accommodating an image sensing device with an optical component holding member for holding an optical component, and to a camera using such an image pickup device.

2. Description of the Related Art

There are image pickup devices which use a solid state image sensing device of CCD type, MOS type or amplification type. FIG. 3 is a sectional view showing a conventional example of such an image pickup device.

In the drawing, numeral 1 indicates a printed circuit board to which an image pickup device 2 as mentioned above is mounted. Numeral 3 indicates a package accommodating a solid state image sensing device 4 and formed, for example, of ceramic or resin. Numeral 5 indicates a seal glass for sealing the solid state image sensing device 4 accommodated in the package 3. Numeral 6 indicates a barrel, which is mounted to the printed circuit board 1. The barrel 6 surrounds the package 3 accommodating the solid state image sensing device 4. The relative positioning of the package 3 and the barrel 6 in the X and Y-directions (two directions which are at right angles to each other in a plane parallel to the surface of the image sensing device 4) is effected by means of an abutting section (not shown). Numeral 7 indicates a female screw formed substantially on the upper half of the inner surface of the barrel 6. The female screw 7 is threadedly engaged with a male screw 9 of an optical component mounting member 8, whereby the barrel 6 and the optical component mounting member 8 are secured to each other.

The optical component mounting member 8 is substantially cylindrical. The inner diameter of the forward end portion of the optical component mounting member 8 is smaller than that of the other portion thereof, whereby an engagement step portion is formed. Inside the optical component mounting member 8, a lens 10, an infrared intercepting filter 11, a diaphragm 12 and a lens 13 are secured in position by means of adhesive or the like. Numeral 14 indicates the aperture of the diaphragm 12. In this image pickup device, the positional relationship between the optical components 10, 11, 12 and 13 and the image sensing device 4 can be set in a predetermined manner with respect to the X and Y-directions due to the abutment of the barrel 6 and the package 3 by virtue of the above-mentioned abutting section. With respect to the Z-direction (the direction perpendicular to the surface of the image sensing device 4), however, their positional relationship must be adjusted by the distance through which the optical component holding member 8 is threaded in the barrel 6.

The conventional image pickup device 2 shown in FIG. 3 has the following problems: first, the barrel 6 has to be provided between the package 3 accommodating the image sensing device 4 and the optical component holding member 8 for holding the optical components 10, 11, 12 and 13. Further, it is also necessary to provide screws, adhesive or the like to mount the barrel 6 to the printed circuit board 1, etc., which means a large number of parts are required, resulting in the material cost of the image pickup device 2 being rather high. Furthermore, it is difficult to achieve a reduction in size, which is much required nowadays, and an increase in assembly man-hours is entailed.

Second, it is necessary to provide adhesive, screws or the like to secure the optical components 10, 11, 12 and 13 to the optical component holding member 8, and the securing operation requires an amount of man-hours which cannot be ignored.

Third, since the optical component holding member 8 is threadedly engaged with the barrel 6, the structure of these members is rather complicated. Moreover, due to the backlash entailed, the adjustment of the focal length is rather difficult to perform. Furthermore, to adjust the focal length through the adjustment of the distance through which the optical component holding member 8 is threaded in the barrel, wiring has to be effected so as to connect the image pickup device 2 to a driving circuit, and it is necessary to perform image pickup and to conduct the difficult operation of adjusting the distance through which the optical component holding member 8 is threaded in the barrel while watching the reproduced image taken. This operation is very troublesome and requires an amount of man-hours which cannot be ignored. Further still, the focal length will not stay in adjustment due to loosening of the screws, etc.

### SUMMARY OF THE INVENTION

The present invention has been made with a view toward eliminating the above problems. Accordingly, it is an object of the present invention to achieve a reduction in the number of parts, to meet the demand for a reduction in size, to facilitate the adjustment of the focal length, and to prevent the focal length from going out of adjustment.

In a first aspect of the present invention, there is provided an image pickup device, wherein a part of an image sensing device accommodating package for accommodating an image sensing device is engaged with a part of an optical component holding member for holding an optical component for forming an image of an object on the surface of the image sensing device, whereby an integral unit is obtained, with a certain positional relationship between the optical component and the image sensing device in the X, Y and Z-directions being determined.

Thus, in the image pickup device according to the first aspect of the invention, the image sensing device accommodating package is directly mounted to the optical component holding member, and there exists no such member as a barrel therebetween, so that a reduction in the number of parts is achieved, and the demand for a reduction in size can be met. Further, by engaging a part of the package with a part of the optical component holding member, an integral unit is obtained, and, at the same time, the positioning of the optical component and the image sensing device in the X, Y and Z-directions can be effected, whereby the assembly is facilitated to a great degree, making it possible to remarkably reduce the assembly man-hours. Of course, the integration is not effected through threaded engagement of male and female screws, so that there is no backlash. Since no threaded engagement is adopted for the integration of the image sensing device accommodating package and the optical component holding member, there is no concern that the focal length will go out of adjustment.

In a second aspect of the invention, there is provided an image pickup device, wherein, in the image pickup device according to the first aspect of the invention, a spacer is provided between the package and the optical component holding member, the distance between the optical component and the image sensing device in the Z-direction being adjusted to a predetermined value by virtue of the presence of the spacer.

Thus, in the image pickup device according to the second aspect of the invention, a spacer for adjusting the focal distance is provided between the package and the optical component, so that, by measuring the height of the surface of the image sensing device with respect to the package in advance, it is possible to set the distance between the image sensing device and the optical component to a predetermined value by selecting a spacer having a thickness corresponding to that height. Thus, there is no need to perform focal length adjustment by means of an image taken, whereby the operation of adjusting the focal length is remarkably facilitated.

In a third aspect of the invention, there is provided an image pickup device in which, in the image pickup device of the first and second aspects of the invention, a biasing means for biasing the optical component toward the package is provided between the image sensing device accommodating package and the optical component.

Thus, in the image pickup device of the third aspect of the invention, the optical component is biased toward the package by the biasing means, so that, even when there is a dimensional error in the optical component holding member or the optical component, the distance between the optical component and the image sensing device can be reliably adjusted, whereby it is possible for the focal length adjusting function to be reliably brought into play. Further, due to the biasing means, it is possible to maintain the condition in which the image sensing device accommodating package and the optical component holding member are integrated with each other.

In a fourth aspect of the invention, there is provided a camera using an image pickup device according to the first, second or third aspect of the invention.

Thus, in the camera of the fourth aspect of the invention, it is possible to enjoy the advantages of the image pickup device of the first, second or third aspect of the invention.

Basically, in accordance with the present invention, a part of an image sensing device accommodating package accommodating an image sensing device is engaged with a part of an optical component holding member holding an optical component for forming an image of an object on a surface of the image sensing device, whereby an integral unit is obtained, with a certain positional relationship between the optical component and the image sensing device in the X, Y and Z-directions being determined.

It is also possible to adjust the distance between the optical component and the image sensing device, that is, the focal length, to a predetermined value by providing a spacer between the package and the optical component holding member.

Further, the optical component may be biased toward the package by a biasing means. The biasing means may be an elastic member, such as an O-ring or a spring.

The image sensing device may be a solid state image sensing device of CCD type, MOS type or amplification type. The image sensing device accommodating package may be a ceramic package or a resin package. The optical component comprises a lens, which is indispensable in forming an object image. Apart from this, an infrared intercepting filter, etc. may be used. While it is possible to use a single lens, it is also possible to use a plurality of lenses. In some cases, a diaphragm is held in the optical component holding member as an optical component, and, in other cases, the diaphragm is provided in the optical component holding member itself. The spacer is made of metal or resin, and its thickness is controlled with high accuracy in the order, for example, of ± several μm. Specifically, spacers of different thicknesses, for example, 1 mm, 1.05 mm, and 0.95 mm, are prepared in accordance with the depth of focus of the lens. When there is no problem in focal length, the 1 mm thick spacer is used. When the distance between the optical component and the image sensing device is approximately 50 μm too large, the 0.95 mm thick spacer is used. Of course, an error in focal length corresponding to the depth of focus of the lens does not affect the image, and is permissible. Thus, when the variation in focal length is within the range of the depth of focus, it is only necessary to provide a single kind of spacer. In this case, the lens and the spacer may be formed as an integral unit.

The above-mentioned values are only given by way of example, and should not be construed restrictively.

### BRIEF DESCRIPTION OF THE DRAWINGS

FIG. 1 is a sectional view showing an image pickup device according to a first embodiment of the present invention;

FIG. 2 is a sectional view showing an image pickup device according to a second embodiment of the present invention;

FIG. 3 is a sectional view showing a conventional example; and

FIG. 4 is a schematic diagram showing a camera using an image pickup device according to the present invention.

### DESCRIPTION OF THE PREFERRED EMBODIMENTS

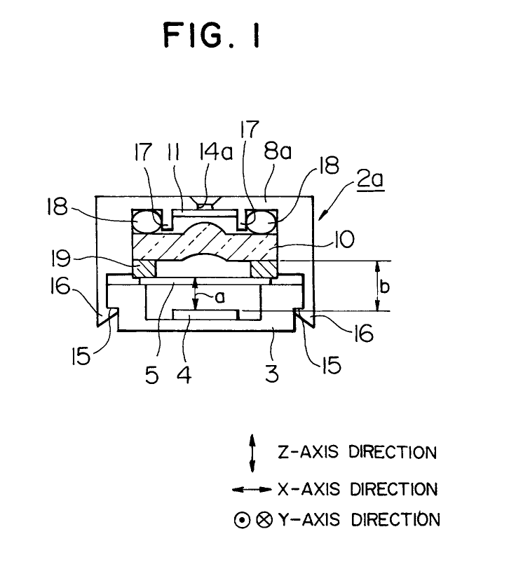

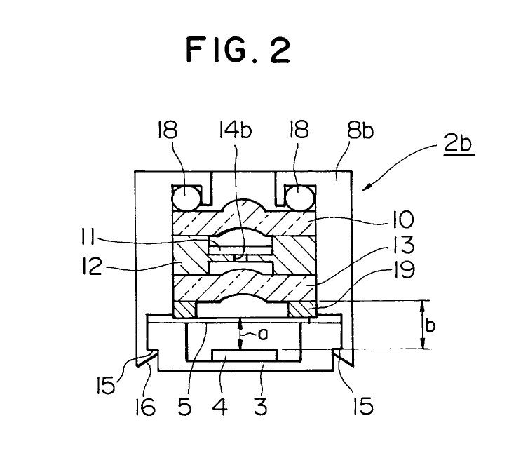

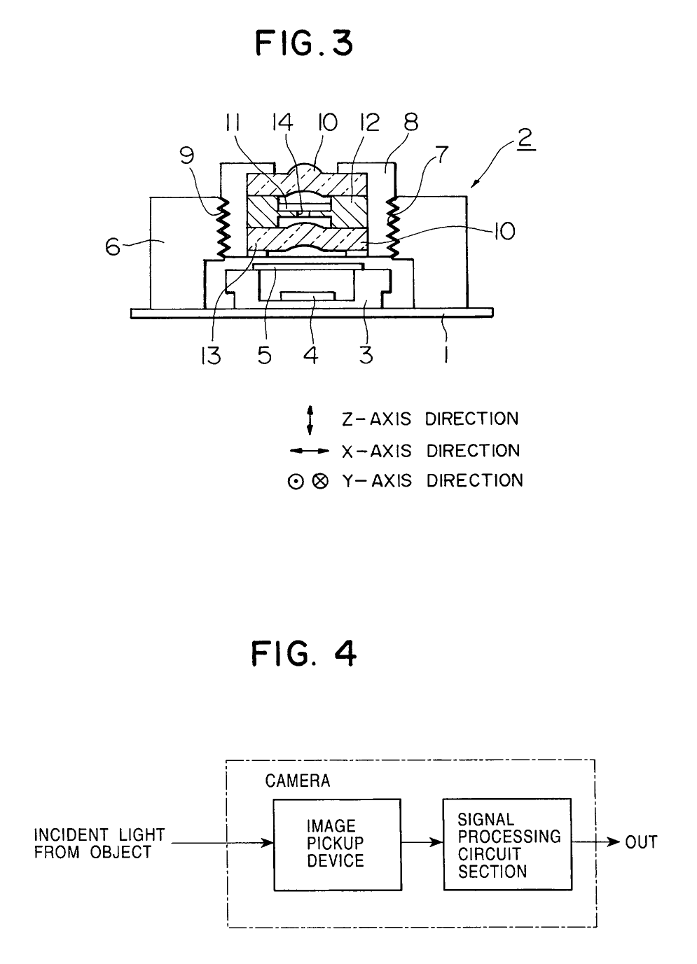

The present invention will now be described in detail with reference to the embodiments shown in the drawings. FIG. 1 is a sectional view showing an image pickup device 2a according to the first embodiment of the present invention, and FIG. 2 is a sectional view showing an image pickup device 2b according to the second embodiment of the present invention. The image pickup device 2a of the first embodiment differs from the image pickup device 2b of the second embodiment in the composition of the optical components. The number of lenses 10 is larger in the image pickup device 2b than in the image pickup device 2a, and, consequently, the device 2b is more complicated and larger in size than the device 2a. However, essentially, the two devices have a great deal in common, so they will be described together. In the drawings, numeral 3 indicates an image sensing device accommodating package, numeral 15 indicates a downwardly directed engagement step formed on the outer side surface of the image sensing device accommodating package 3, numeral 4 indicates a solid state image sensing device accommodated in the image sensing device accommodating package 3, and numeral 5 indicates a seal glass for sealing the solid state image sensing device 4. The distance a in the Z-direction between the surface of the image sensing device 4 in the package 3 and the surface of the seal glass 5 is set to a predetermined value. However, there is a difference between the actual value and the preset value of this distance. In view of this, the distance a is correctly measured after the image sensing device 4 has been accommodated in the package 3 and sealed by the seal glass 5.

Numerals 8a and 8b indicate optical component holding members. Each of them is formed, for example, of resin or metal, as a container whose lower end is open, and has at its lower end an elastic engagement claw (hook) 16 adapted to be engaged with the engagement step 15. Numerals 10 and 13 indicate lenses, numeral 11 indicates an infrared intercepting filter, numeral 14a indicates an aperture formed in the upper wall of the optical component holding member 8a, 8b, numeral 12 indicates a diaphragm, numeral 14b indicates the aperture of the diaphragm 12, numeral 17 indicates an O-ring holding protrusion formed on the inner surface of the optical component holding member 8a, 8b and directed downwards, and numeral 18 indicates an O-ring which is fitted around the O-ring holding protrusion 17 and which has a thickness larger than the height of the protrusion 17.

Numeral 19 indicates a spacer, which is provided between the optical component (lens) 10 (in the case of the device 2b of the second embodiment, the lens 10, the diaphragm 12, the infrared intercepting filter 11 and the lens 13) and the seal glass 5 of the image sensing device accommodating package 3.

A plurality of types of spacer 19 having different thicknesses of, for example, 1 mm, 1.05 mm and 0.95 mm, are prepared. By using a spacer 19 according to the distance a in the Z-direction between the surface of the image sensing device 4 of the package 3 and the surface of the seal glass 5, it is always possible to set the distance between the surface of the image sensing device 4 and the optical component 10 or 13 to a predetermined value b. Of course, some error is entailed, which, however, is permissible as long as it is within the range of the depth of focus.

When the type of image pickup device is determined, the proper value of the distance between the surface of the solid state image sensing device 4 and the optical component 10 or 13 is determined. Suppose the value is b. It is possible for the value to be departed from b due to some error on the image sensing device accommodating package 3 side. The error factors include a variation in the thickness of the solid state image sensing device 4, a variation in the thickness of the adhesive (not shown) for gluing it to the bottom portion of the package 3, a variation in the thickness of the seal glass 5, and a variation in the thickness of the adhesive (not shown) for gluing the seal glass 5 to the package 3. Thus, there are not a few error factors. In view of this, the distance a between the surface of the image sensing device 4 in the image sensing device accommodating package 3 and the surface of the seal glass 5 is measured in advance.

This distance a is used as a reference. For example, the 1 mm thick spacer 19 is used when there is no problem with the distance a, i.e., when the spacer of this thickness enables the distance b to attain the predetermined value. When the distance a is such that the distance between the optical component and the image sensing device would be approximately 50 μm too large if the 1 mm thick spacer were used, the 0.95 mm thick spacer is used. Conversely, when the distance a is such that the distance between the optical component and the image sensing device would be approximately 50 μm too small if the 1 mm thick spacer were used, the 1.05 mm thick spacer is used. In this way, it is possible to keep the distance between the surface of the solid state image sensing device 4 and the optical component 10 or 13 at a predetermined value. An error in the distance b is permissible as long as it is within the range of the depth of focus; no problem will be generated in the image within that range. Thus, by preparing spacers 19 having different thicknesses in a number corresponding to the value obtained by dividing the expected span of variation by the depth of focus of the optical system, it is possible for the variation in size to be reliably coped with by selecting an appropriate spacer 19 from them.

When the span of variation is within the depth of focus, it is only necessary to prepare a single kind of spacer having a fixed thickness. In this case, the spacer 19 and the lens 10 or 13 may be formed into an integral unit.

When assembling the image pickup device, the infrared intercepting filter 11, the O-ring 18, the lens 10, 13, the diaphragm 12, etc. are set in the optical component holding member 8a, 8b. In the first embodiment, it is necessary to secure the infrared intercepting filter 11 to the optical component holding member 8a, but the other components need not be secured by adhesion or the like to the optical component holding member 8a, 8b. A spacer 19 which has a thickness corresponding to the measured distance a, is brought into contact with the lens 10, 13. The optical component holding member 8a, 8b is snapped onto the package 3. Specifically, the package 3 is forced between the elastic engagement claws 16, which are thereby spaced apart and then engaged with the engagement step 15 on the side surface of the package 3, whereby the image pickup device is completed. This state is maintained by virtue of the elasticity of the O-ring 18.

In this image pickup device, the image sensing device accommodating package 3 and the optical component holding member 8a, 8b are directly combined with each other, with no such member as a barrel existing therebetween, whereby the number of parts is reduced and the demand for a reduction in size can be met. Further, the package 3 can be snapped into the optical component holding member 8a, 8b to form an integral unit through engagement of the engagement step 15 with the engagement claws 16. At the same time, the positioning of the optical components 10, 13, etc. in the X, Y and Z-directions with respect to the image sensing device 4 can be effected, whereby the assembly is greatly facilitated, and the assembly man-hours can be remarkably reduced. It goes without saying that no backlash is entailed since the integration is not effected through threaded engagement of male and female screws. Since threaded engagement is not adopted as the means for integrating the image sensing device accommodating package 3 with the optical component holding member 8a, 8b, there is no concern that the focal length will not stay in adjustment after the adjustment of the focal length.

Further, the spacer 19 for focal length adjustment is provided between the package 3 and the optical component 10, 13, and the distance a between the surface of the image sensing device 4 and the surface of the seal glass 5 is measured in advance. Due to this arrangement, it is possible to set the distance b between the image sensing device and the optical component to the predetermined value by selecting a spacer 19 having a thickness corresponding to that distance a. Thus, there is no need to perform focal length adjustment by using the image taken, whereby the operation of adjusting the focal length is remarkably facilitated.

Since the O-ring 18, which is a biasing means, biases the optical components 10, 13, etc. toward the package 3, it is possible to reliably adjust the distance between the optical component 10, 13 and the solid state image sensing device 4 by means of the spacer 19 even if there is some dimensional error in the optical component holding member 8a, 8b or the optical component 10, 13, whereby the focal length adjusting function can be reliably brought into play. In other words, the above-mentioned dimensional error can be absorbed by the O-ring 18. While in this embodiment the O-ring 18 is used as the biasing means, this should not be construed restrictively. Any other type of member will serve the purpose as long as it is elastic.

As shown in FIG. 4, by performing signal processing on image information from the image pickup device by a signal processing circuit section, this image pickup device can be used as an image pickup means in various types of cameras, such as a video camera for home use, an endoscope, and a monitoring camera. When equipped with the above-described image pickup device, these cameras can enjoy the various advantages of this image pickup device.

In the image pickup device according to the first aspect of the invention, the image sensing device accommodating package and the optical component holding member are directly combined with each other, and no such member as a barrel exists therebetween, whereby the number of parts is reduced, and the demand for a reduction in size can be met. Further, by engaging a part of the package with a part of the optical component holding member, they can be formed into an integral unit, and, at the same time, the positioning of the optical component in the X, Y and Z-directions with respect to the image sensing device can be effected, whereby the assembly is facilitated to a remarkable degree, and the assembly man-hours can be remarkably reduced. Of course, no backlash is entailed since the integration is not effected through threaded engagement of male and female screws. Since threaded engagement is not adopted as the means for integrating the image sensing device accommodating package with the optical component holding member, there is no concern that the focal length will not stay in adjustment after the adjustment of the focal length.

In the image pickup device according to the second aspect of the invention, a spacer for adjusting the focal length is provided between the package and the optical component, so that, by measuring the height of the surface of the image sensing device with respect to the package in advance, it is possible to set the distance between the image sensing device and the optical component to a predetermined value by selecting a spacer having a thickness corresponding to that height, whereby there is no need to perform focal length adjustment by using the image taken, thereby remarkably facilitating the operation of adjusting the focal length.

In the image pickup device according to the third aspect of the invention, the optical component is biased toward the package by a biasing means, so that it is possible to reliably adjust the distance between the optical component and the image sensing device even if there is some dimensional error in the optical component holding member or the optical component, whereby the focal length adjusting function can be reliably brought into play.

In the camera according the fourth aspect of the invention, it is possible to enjoy the advantages of the image pickup device according to the first, second or third aspect of the invention.

What is claimed is:

1. An image pickup device at least comprising:
an image sensing device accommodating package accommodating an image sensing device, and
an optical component holding member holding an optical component for forming an image of an object on a surface of the image sensing device,
wherein a part of the image sensing device accommodating package is engaged with a part of the optical component holding member, whereby an integral unit is obtained, with a certain positional relationship between the optical component and the image sensing device in the X and Y-directions in a plane parallel to the surface of the image sensing device and in the Z-direction perpendicular to the surface being determined.

2. An image pickup device according to claim 1, wherein the image sensing device accommodating package has an engagement step portion.

3. An image pickup device according to claim 1, wherein the optical component holding member has an engagement claw.

4. An image pickup device according to claim 1, wherein a spacer is provided between the package and the optical component holding member, the distance between the optical component and the image sensing device in the Z-direction being adjusted to a predetermined value by the spacer.

5. An image pickup device according to claim 1 or 2, further comprising biasing means for biasing the optical component toward the package.

6. A camera equipped with an image pickup device, comprising:
an image pickup device including an image sensing device accommodating package accommodating an image sensing device, and an optical component holding member holding an optical component for forming an image of an object on a surface of the image sensing device, wherein a part of the image sensing device accommodating package is engaged with a part of the optical component holding member, whereby an integral unit is obtained, with a certain positional relationship between the optical component and the image sensing device in the X and Y-directions in a plane parallel to the surface of the image sensing device and in the Z-direction perpendicular to the surface being determined, and
an image signal processing circuit for performing signal processing on image data represented by an electric signal obtained through photoelectric conversion of the optical image of the object formed on the surface of the image sensing device.

7. A camera equipped with an image pickup device according to claim 6, wherein the image sensing device accommodating package has an engagement step portion.

8. A camera equipped with an image pickup device according to claim 6, wherein the optical component holding member has an engagement claw.

9. A camera equipped with an image pickup device according to claim 6, wherein a spacer is provided between the package and the optical component holding member, the distance between the optical component and the image sensing device in the Z-direction being adjusted to a predetermined value by the spacer.

10. A camera equipped with an image pickup device according to claim 6, further comprising biasing means for biasing the optical component toward the package.
